(19) United States
(12) Patent Application Publication
(10) Pub. No.: US 2023/0349218 A1
(43) Pub. Date: Nov. 2, 2023

(54) Hoodpin Actuator for Securing the Hood of a Vehicle

(71) Applicant: Tyler Witt, Roundrock, TX (US)

(72) Inventor: Tyler Witt, Roundrock, TX (US)

(21) Appl. No.: 17/734,292

(22) Filed: May 2, 2022

(51) Int. Cl. E05F 15/53; B62D 25/12; B60R 16/033

(52) U.S. Cl. CPC E05F 15/53; B62D 25/12; B60R 16/033; E05Y 2201/448; E05Y 2900/536

(57) ABSTRACT

The invention relates to a hoodpin actuator for securing the hood of a vehicle. The vehicle includes a vehicle body, a hood for covering an engine bay and the batteries placed under the vehicle, and a hoodpin actuator configured for securing the hood to the vehicle body. The hoodpin actuator includes a head coupled to the hood, a base coupled to the vehicle body. Further, the hoodpin actuator includes an internal hydraulic to protrude the head away from the base to move the hood relative to the vehicle body.

### FIELD OF THE DISCLOSURE

This invention generally relates to securing the hood of a vehicle and is more particularly related to a hoodpin actuator for securing the hood of the vehicle and efficient cooling of the engine bay.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

During the running of the vehicle, the engine bay of the vehicle heats up and may lead to overheating causing damages such as, engine damage, wiring damage and battery damage that can cost a fortune to the vehicle owner. Therefore, the engine bay of the vehicle and the batteries placed under the vehicle requires efficient handling for the proper running of the vehicle. Over the years, various mechanisms have been adapted for cooling the engine bay of the vehicle. Conventionally, the hood scoops are used for supplying air to the engine bay while running the vehicle for cooling the engine bay and the batteries placed under the vehicle. The supplied air also leads to ram air intake by directly feeding air to the motor and improving the engine power while cooling the engine.

However, the hood scoops are limited to providing a cooling effect during the running of the vehicle and are not efficient in providing cooling during idle states, such as parking. The limited use is mainly due to the limited orifice that the hood scoop provides. Further, the limited orifice also does not provide enough airflow for the engine bay and the batteries placed under the vehicle to cool down efficiently and can be improved drastically. Additionally, the high-velocity air through the hood scoop exerts a large force on the hood leading to the breaking of the hood joints while driving. The breaking of the hood joints may lead to the flying of the hood on the windshield affecting the visibility of the driver may lead to accidents.

Therefore, there is a need for a mechanism to supply a large amount of air to the engine bay and the batteries placed under the vehicle while keeping the hood secure from breaking and flying up while driving.

### OBJECTIVES OF THE INVENTION

It is an objective of the invention to provide a mechanism for supplying a large amount of air into the engine bay for efficient cooling of the engine bay.

It is another objective of the invention to provide the mechanism for supplying a large amount of air into the batteries placed under the vehicle for efficient cooling of the batteries.

It is another objective of the invention to provide the mechanism for cooling the engine bay with or without batteries and the batteries placed under the vehicle during the idle state of the vehicle.

It is yet another embodiment of the invention to provide the mechanism for cooling the engine bay and the batteries placed under the vehicle during the running state of the vehicle.

It is yet another objective of the invention to provide the mechanism for cooling the engine bay and the batteries placed under the vehicle while keeping the hood securely attached to the vehicle.

It is yet another embodiment of the invention to provide the mechanism for cooling the engine bay and the batteries placed under the vehicle that is operable by a button.

### SUMMARY

The present invention discloses a vehicle according to an embodiment of the present invention. The vehicle includes a vehicle body, a hood for covering an engine bay and the batteries placed under the vehicle, and a hoodpin actuator configured for securing the hood to the vehicle body. Further, the hoodpin actuator includes a head coupled to the hood and a base coupled to the vehicle body. The hoodpin actuator also includes an internal hydraulic to protrude the head away from the base to move the hood relative to the vehicle body. In an embodiment the engine bay may comprises an engine with or without battery. In an embodiment, the battery may be placed under the vehicle.

In an embodiment of the present invention, the vehicle also includes a relay to supply power to the hoodpin actuator via a power cord for moving the hood relative to the vehicle body, a processor to command the relay to supply the power to the hoodpin actuator; and a button configured to control the operation of the internal hydraulic by sending an actuation signal to the processor.

In an embodiment of the present invention, the actuation signal is associated with at least one of: opening of the hood, closing of the hood, angle of opening of the hood and angular speed of opening of the hood.

In an embodiment of the present invention, the vehicle further includes a battery to provide power to at least one of: the relay and the processor and a timer to automatically close the hood after a predefined time interval. The predefined time interval is 5 mins.

In an embodiment of the present invention, during the open position, the hood moves upwards to a predefined gap between the hood and the vehicle body. Further, the gap is in a range of 2-5 inches.

In an embodiment of the present invention, the hoodpin actuator is secured inside a bracket having a hoodpin actuator holder and an outer cover. Further, the hoodpin actuator is configured to supply a large amount of air to the batteries placed under the vehicle for efficient cooling of the batteries.

The present invention discloses a hoodpin actuator for securing the hood to the vehicle body according to an embodiment of the present invention. Further, the hoodpin actuator includes a head coupled to the hood and a base coupled to the vehicle body. The hoodpin actuator also includes an internal hydraulic to protrude the head away from the base to move the hood relative to the vehicle body.

In an embodiment of the present invention, a relay to supply power to the hoodpin actuator via a power cord for moving the hood relative to the vehicle body, a processor to command the relay to supply the power to the hoodpin actuator; and a button configured to control the operation of the internal hydraulic by sending an actuation signal to the processor.

In an embodiment of the present invention, the actuation signal is associated with at least one of: opening of the hood, closing of the hood, angle of opening of the hood and angular speed of opening of the hood.

In an embodiment of the present invention, a battery is configured to provide power to at least one of: the relay and the processor, and a timer is configured to automatically close the hood after a predefined time interval. The predefined time interval is 5 mins.

In an embodiment of the present invention, during the open position, the hood moves upwards to a predefined gap between the hood and the vehicle body. Further, the gap is in a range of 2-5 inches.

In an embodiment of the present invention, a bracket is configured to secure the hoodpin actuator inside, the bracket having a hoodpin actuator holder and an outer cover. Further, the hoodpin actuator is configured to supply a large amount of air to the batteries placed under the vehicle for efficient cooling of the batteries.

The disclosed embodiments encompass numerous advantages. Various embodiments of a hoodpin actuator for securing the hood of the vehicle have been disclosed. Further, the disclosed hoodpin actuator provides a mechanism for supplying a large amount of air into the engine bay for efficient cooling of the engine bay. Further, the hoodpin actuator provides a mechanism to supply a large amount of air to the batteries placed under the vehicle for efficient cooling of the batteries. The disclosed hoodpin actuator provides the mechanism for cooling the engine bay and the batteries placed under the vehicle during the idle state of the vehicle. Further, the hoodpin actuator provides the mechanism for cooling the engine bay and the batteries placed under the vehicle during the running state of the vehicle. The hoodpin actuator also provides the mechanism for cooling the engine bay and the batteries placed under the vehicle while keeping the hood securely attached to the vehicle. Additionally, the hoodpin actuator provides the mechanism for cooling the engine bay and the batteries placed under the vehicle operable by a button.

Further, the hoodpin actuator may be configured to extend to decrease aerodynamics for slowing down of the vehicle. Thus, the hoodpin actuator may be used in vehicles on closed race courses and timed events to add additional braking force.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a front perspective view of a hoodpin actuator in accordance with an embodiment of the present invention;

FIG. 2 illustrates the hoodpin actuator installed in a vehicle in accordance with an embodiment of the present invention;

FIG. 3 illustrates a circuitry of the hoodpin actuator in the vehicle in accordance with an embodiment of the present invention;

FIG. 4A illustrates a bracket for holding the hoodpin actuator in accordance with an embodiment of the present invention;

FIG. 4B illustrates a hoodpin actuator holder of the bracket in accordance with an embodiment of the present invention; and

FIG. 4C illustrates an outer cover of the bracket in the vehicle in accordance with an embodiment of the present invention.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

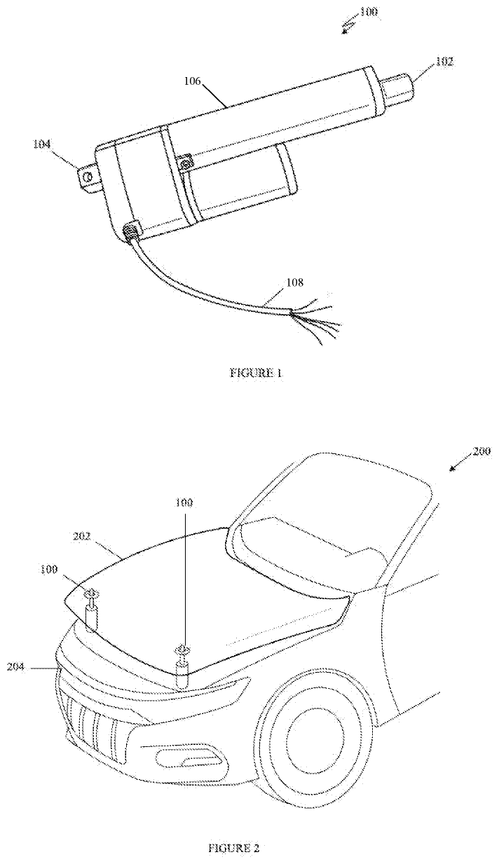

FIG. 1 illustrates a front perspective view of a hoodpin actuator 100 in accordance with an embodiment of the present invention. In an embodiment of the present invention, the hoodpin actuator 100 may include a head 102, a base 104, an internal hydraulic 106, and a power cord 108. FIG. 1 has been explained in conjunction with FIG. 2.

FIG. 2 illustrates the hoodpin actuator 100 installed in a vehicle 200 in accordance with an embodiment of the present invention. In an embodiment of the present invention, the head 102 may be coupled to the hood 202 of the vehicle 200. It may be understood that the head 102 may be coupled at any place, as per the requirements, on the hood 202 without departing from the scope of the invention. Further, the head 102 may be coupled to the hood 202 by one or more fastening means known in the art. In an embodiment of the present invention, the one or more fastening means may without any limitation include, welding, nut and screw, snaps, rivots, or the like.

In an embodiment of the present invention, the base 104 may be coupled to the vehicle body 204. It may be understood that the base 104 may be coupled at any place, as per the requirements, on the vehicle body 204 without departing from the scope of the invention. Further, the base 104 may be coupled to the vehicle body 204 by one or more fastening means known in the art. In an embodiment of the present invention, the one or more fastening means may without any limitation include, welding, nut and screw, snaps, rivots, or the like.

In an embodiment of the present invention, the hoodpin actuator 100 may be installed at an appropriate location on the vehicle 200 for supply a large amount of air to the batteries placed under the vehicle 200 for efficient cooling of the batteries. Such a scenario may especially be useful in case of Electric Vehicle (EV) such as, without any limitation, electric cars.

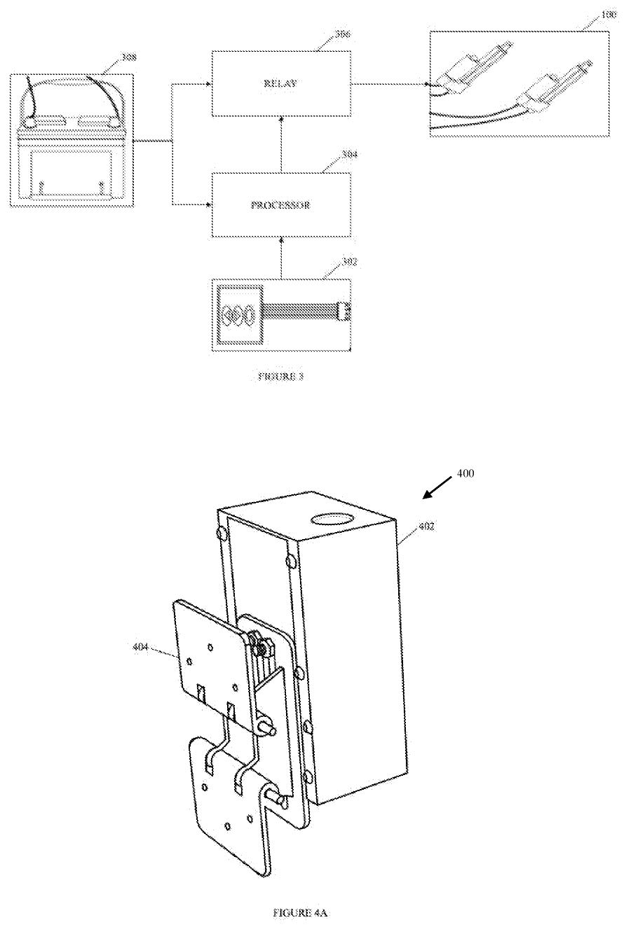

In an embodiment of the present invention, the internal hydraulic 106 may be configured to protrude the head 102 in an axially outward direction with respect to the base 104. Consequently, the internal hydraulic 106 may be configured to protrude the head 102 away from the base 104 to move the hood 202 relative to the vehicle body 204. In an embodiment of the present invention, the internal hydraulic 106 may be an electronically operated hydraulic. Thus, to protrude the head 102 away from the base 104, the hoodpin actuator 100 may be communicatively coupled to a circuitry, as shown in FIG. 3. FIG. 3 illustrates the circuitry of the hoodpin actuator 100 in the vehicle in accordance with an embodiment of the present invention.

In an embodiment of the present invention, the circuitry may include a button 302, a processor 304, a relay 306, and a battery 308. Further, the button 302 may be configured to facilitate the user to control the operation of the internal hydraulic 106 by sensing an actuation signal to the processor 304. The actuation signal may be associated with opening of the hood 202, closing of the hood 202, an angle of opening of the hood 202, angular speed of opening of the hood, or a combination thereof. For example, the actuation signal may include opening of the hood 202 at an angle of 20 degrees or the actuation signal may include opening of the hood 202 at an angular speed of 50 degrees per minute.

In an embodiment of the present invention, the processor 304 may be a microprocessor, a microcontroller, or any other processor known in the art. Further, the processor 304 may include a memory. The memory may be a physical memory or a cloud-based memory. Further, the processor 304 may be configured to control the operation of the relay 306 based on the actuation signal received from the button 302.

In an embodiment of the present invention, the relay 306 may be configured to supply the power to the hoodpin actuator 100 for moving the hood 202 relative to the vehicle body 204. The relay 306 may be configured to supply the power via the power cord 108 of the hoodpin actuator 100. For example, the button 302 may send an actuation signal to the processor 304 for opening the hood 202, consequently, the processor 304 may send a command to the relay 306 to supply optimum power to the hoodpin actuator 100 for opening the hood 202 of the vehicle 200.

In an embodiment of the present invention, the battery 308 may be the battery associated with the vehicle 200. In another embodiment of the invention, the battery 308 may an external battery. Further, the external battery may include a rechargeable battery or a non-rechargeable battery. The battery 308 may be coupled to the processor 304 and the relay 306 to supply the power required for the operation of the processor 304 and the relay 306.

In an embodiment of the present invention, the circuitry may include a timer (not shown) coupled to the processor for automatically closing the hood after a pre-defined time interval. In an embodiment of the present invention, the predefined time interval maybe 5 minutes. Further, the hoodpin actuator 100 may move the hood 202 upwards with respect to the vehicle body 204 up to a predefined gap during an open position. In an embodiment of the present invention, the predefined gap maybe in a range of 2-5 inches.

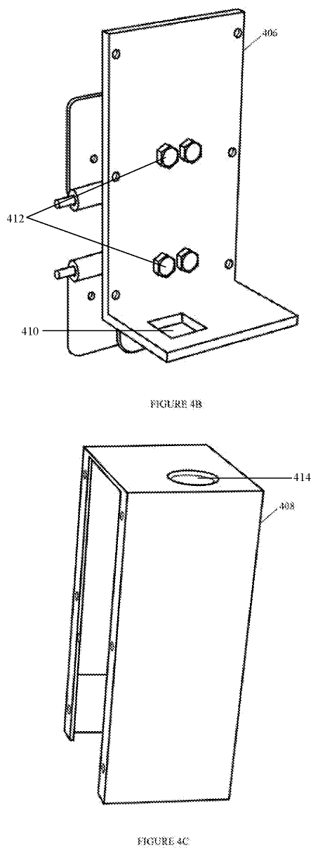

FIG. 4A illustrates a bracket 400 for holding the hoodpin actuator 100 in accordance with an embodiment of the present invention. FIG. 4B illustrates a hoodpin actuator holder 406 of the bracket 400 in accordance with an embodiment of the present invention. FIG. 4C illustrates an outer cover 408 of the bracket 400 in the vehicle 200 in accordance with an embodiment of the present invention. For the sake of brevity, the FIGS. 4A, 4B, and 4C have been explained together.

In an embodiment of the present invention, the bracket 400 may include a body 402 and a mounting means 404. Further, the body 402 may include a hoodpin actuator holder 406 and an outer cover 408 coupled to one another via one or more fastening means known in the art. In an embodiment of the present invention, the hoodpin actuator holder 406 may include a hole 410, as shown in FIG. 4B. The hole 410 may be configured to receive the base 104 of the hoodpin actuator 100. Further, the hoodpin actuator holder 406 may be coupled to the mounting means 404 via one or more fastening means 412 such as nut and screw.

In an embodiment of the present invention, the outer cover 408 may include a hole 414, as shown in FIG. 4C. The hole 414 may be configured to receive the head 102 of the hoodpin actuator 100. Further, the hoodpin actuator holder 406 may be coupled to the mounting means 404 via one or more fastening means such as nut and screw.

In an embodiment of the present invention, the mounting means 404 may be coupled to the vehicle 200 via one or more fastening means known in the art. In an embodiment of the present invention, the one or more fastening means may without any limitation include, welding, nut and screw, snaps, rivots, or the like.

The disclosed embodiments encompass numerous advantages. Various embodiments of a hoodpin actuator 100 for securing the hood of the vehicle have been disclosed. Further, the disclosed hoodpin actuator 100 provides a mechanism for supplying a large amount of air into the engine bay for efficient cooling of the engine bay. Further, the hoodpin actuator 100 provides a mechanism to supply a large amount of air to the batteries placed under the vehicle for efficient cooling of the batteries. The disclosed hoodpin actuator 100 provides the mechanism for cooling the engine bay and the batteries placed under the vehicle during the idle state of the vehicle. Further, the hoodpin actuator 100 provides the mechanism for cooling the engine bay and the batteries placed under the vehicle during the running state of the vehicle. The hoodpin actuator 100 also provides the mechanism for cooling the engine bay and the batteries placed under the vehicle while keeping the hood securely attached to the vehicle. Additionally, the hoodpin actuator 100 provides the mechanism for cooling the engine bay and the batteries placed under the vehicle operable by a button.

Further, the hoodpin actuator 100 may be configured to extend to decrease aerodynamics for slowing down of the vehicle 200. Thus, the hoodpin actuator 100 may be used in vehicles 200 on closed race courses and timed events to add additional braking force.

It has thus been seen that the hoodpin actuator for securing the hood of the vehicle according to the present invention achieves the purposes highlighted earlier. The hoodpin actuator for securing the hood of the vehicle can in any case undergo numerous modifications and variants, all of which are covered by the same innovative concept; moreover, all of the details can be replaced by technically equivalent elements. In practice, the materials used, as well as the shapes and sizes, can be whatever according to the technical requirements. The scope of protection of the invention is therefore defined by the attached claims.

What is claimed is:

1. A vehicle comprising:
a vehicle body;
a hood for covering an engine bay and the batteries placed under the vehicle;
a hoodpin actuator configured for securing the hood to the vehicle body, the hoodpin actuator comprising:
a head coupled to the hood;
a base coupled to the vehicle body; and
an internal hydraulic to protrude the head away from the base to move the hood relative to the vehicle body.

2. The vehicle as claimed in claim 1, further comprises:
a relay to supply power to the hoodpin actuator via a power cord for moving the hood relative to the vehicle body;
a processor to command the relay to supply the power to the hoodpin actuator; and
a button configured to control the operation of the internal hydraulic by sending an actuation signal to the processor.

3. The vehicle as claimed in claim 2, wherein the actuation signal is associated with at least one of: opening of the hood, closing of the hood, angle of opening of the hood and angular speed of opening of the hood.

4. The vehicle as claimed in any of the claim 2, further comprises a battery to provide power to at least one of: the relay and the processor.

5. The vehicle as claimed in claim 1, further comprises a timer to automatically close the hood after a predefined time interval.

6. The vehicle as claimed in claim 5, wherein the predefined time interval is 5 mins.

7. The vehicle as claimed in claim 1, wherein during the open position, the hood moves upwards to a predefined gap between the hood and the vehicle body.

8. The vehicle as claimed in claim 7, wherein the gap is in a range of 2-5 inches.

9. The vehicle as claimed in claim 1, wherein the hoodpin actuator is secured inside a bracket having a hoodpin actuator holder and an outer cover.

10. The vehicle as claimed in claim 1, wherein the hoodpin actuator is configured to supply a large amount of air to the batteries placed under the vehicle for efficient cooling of the batteries.

11. A hoodpin actuator for securing the hood to the vehicle body, the hoodpin actuator comprising:
a head coupled to the hood of the vehicle;
a base coupled to the vehicle body; and
an internal hydraulic to protrude the head away from the base to move the hood relative to the vehicle body.

12. The hoodpin actuator as claimed in claim 11, wherein
a relay configured to supply power to the hoodpin actuator for moving the hood relative to the vehicle body;
a processor configured to command the relay to supply the power to the hoodpin actuator; and
a button configured to control the operation of the internal hydraulic by sending an actuation signal to the processor.

13. The hoodpin actuator as claimed in claim 12, wherein the actuation signal is associated with at least one of: opening of the hood, closing of the hood, angle of opening of the hood and angular speed of opening of the hood.

14. The hoodpin actuator as claimed in claim 12, wherein a battery is configured to provide power to at least one of: the relay and the processor.

15. The hoodpin actuator as claimed in claim 11, wherein a timer is configured to automatically close the hood after a predefined time interval.

16. The hoodpin actuator as claimed in claim 15, wherein the predefined time interval is 5 mins.

17. The hoodpin actuator as claimed in claim 11, wherein during the open position, the hood moves upwards to a predefined gap between the hood and the vehicle body.

18. The hoodpin actuator as claimed in claim 17, wherein the gap is in a range of 2-5 inches.

19. The hoodpin actuator as claimed in claim 17, wherein a bracket is configured to secure the hoodpin actuator inside, the bracket having a hoodpin actuator holder and an outer cover.

20. The hoodpin actuator as claimed in claim 11, wherein hoodpin actuator configured to supply a large amount of air to the batteries placed under the vehicle for efficient cooling of the batteries.
